(19) United States
(12) Patent Application Publication
(10) Pub. No.: US 2006/0083763 A1
(43) Pub. Date: Apr. 20, 2006

(54) Method and apparatus for insect repellant system

(76) Inventors: Michael Neale, Innisfil (CA); Michael Beckley, Barrie (CA); Parker Robinson, Barrie (CA)

Correspondence Address: Ralph A. Dowell of DOWELL & DOWELL P.C., 2111 Eisenhower Ave, Suite 406, Alexandria, VA, 22314, US

(21) Appl. No.: 10/966,030

(22) Filed: Oct. 18, 2004

(51) Int. Cl. A01N 25/00; A01N 65/00; B05B 1/14

(52) U.S. Cl. 424/405; 424/742; 424/745; 239/548

(57) ABSTRACT

The present invention is directed to methods, apparatuses and compositions directed to producing a chemical or biological barrier to protect human or animal subjects from insect pests.

### FIELD OF INVENTION

The present invention relates to compositions, methods and apparatuses for repelling flying insects, more particular arthropods and flies, such as mosquitoes, noseeums, blackflies and other flying, biting insects.

### BACKGROUND OF THE INVENTION

Various insect pests, such as flying insects, including but not limited to arthropods (i.e. mosquitoes, noseeums), gnats and flies (house flies, black flies, horse flies, etc.) are a nuisance and may pose a health risk to humans, pets and other domesticated animals, particularly when the people or animals are in the outdoors. There have been numerous attempts to reduce the nuisance and risk factors associated with such insect pests. One such attempt is to utilize various control means for keeping various insect pests from flying or crawling near, flying or crawling on, stinging, biting, harming or otherwise annoying humans, pets and other domesticated animals in exterior spaces, such as backyards, fields, otherwise out of doors, or in environments open to the outdoors.

Many naturally occurring and synthetic insecticides, pesticides and/or insect repellents have been used or developed to kill and/or prevent insects from flying or crawling near, flying or crawling on, stinging, biting, harming or otherwise annoying humans and animals. Such insect repellents (i.e. those compounds that repel insect pests) and/or insecticides/pesticides (i.e. those compounds that kill insect pests) can be applied directly to the skin of humans or animals can be used in clothing, furniture, foodstuffs, or can be used nearby humans or animals, such as in candles or sprays to repell or kill these insect pests.

Some of the naturally occurring material, compounds isolated from naturally occurring material or derivatives thereof, sometimes referred to as “natural” or “organic” include compounds derived from; plants, such as essential oils, pyrethrum (pyrethins), rotenone, ryania, neem oil, etc.; or minerals, such as boric acid, cryolite, or diatomaceous earth as well as derivatives or isolates thereof. Compounds generally referred to as synthetic or man-made chemicals include 2-ethyl-3-hexanediol, 1,1,1-trichloro-2-bis-(p-chlorophenyl)ethane (also known as “DDT”) and N,N-diethyl-3-methylbenzamide (also known as “DEET”).

It is known that compositions derived from organic material, such as plant “essential oils” (e.g., oils produced from various plants & plant parts) have also been shown to have insect repellent and/or insecticide activity, including oils from, but not limited to, citronella, fennel, camphor, eucalyptus, geranium, clove bud oil, pennyroyal and clove powder. Compounds isolated from essential oils as well as derivatives of these isolates also been shown to have insect repellent and/or insecticide activity.

While many natural or organic based insect repellents, insecticides or pesticides have been identified, the effectiveness of many of these has not been maximized. Although citronella for example may present reduced health risks when compared with other repellents or insecticides, citronella and other essential oils may be highly volatile. As a result, any activity that might be present could be lost quickly as the oil evaporates. On the contrary, while synthetic or man-made compounds have been identified as effective insect repellents, insecticides or pesticides, many of the synthetic or man-made chemicals, such as DDT, are known or suspected of causing severe adverse health effects in humans and animals. In addition, many synthetic or man made chemicals may not be easily chemically broken down or biodegraded and, therefore, can persist in the environment for extended periods of time, thus posing additional health and environmental hazards. As such, the use of synthetic or man made chemicals may impact the natural ecosystems into which they are released, affecting complex, evolved systems of the native fauna.

In addition to the drawbacks noted above, both naturally occurring or organic insecticide products (e.g. pyrethrins) as well as synthetic or man made chemicals, act as broad spectrum, indiscriminate insecticides, which as noted below, may not be desirable.

Both synthetic or natural insecticides and insect repellents can be applied directly to a subject (i.e. topical application in creams, sprays or lotions), but may also be used with a variety of application systems (sprayers) to either kill or repel insects. Depending on the nature of the active ingredient, topical application may not be desirable as it can irritate the skin of the subject and may not be cost-effective if a large surface area must be covered. Further, many applicators are not suitable for use in residential areas.

For the reasons noted above, many known methods of reducing the number of flying and/or biting insects in areas occupied by people or animals are inadequate as they do not provide sufficient reduction of the insect pests so as to reduce the nuisance and risk factors associated with those insect pests. There remains, therefore, a need to have an effective system that is suitable for use in different environments, particularly, in a residential environment.

### SUMMARY OF THE INVENTION

The present invention is directed to methods, apparatuses and compositions for reducing the number of insect pests within a given area occupied by people or animals so as to reduce the nuisance and risk factors associated with these insect pests.

In accordance with an aspect of the present invention, there is provided a system for use in decreasing the number of insects within an area to be protected, the system comprising a pump for pumping a liquid insect repellent formulation from a reservoir into a transmission line and pressurizing the liquid insect repellent formulation within the transmission line, the transmission line having at least one atomizing assembly operably connected to the transmission line so that when the liquid insect repellent formulation is pressurized in the transmission line the liquid insect repellent formulation is released from the atomizing assembly as an atomized mist.

An aspect of the present invention also provides that the pump can be cycled on and off by a controller, which can be programmable.

In another aspect of the present invention, the atomizing assembly is comprised of a nozzle adapter and an atomizing nozzle operably connected to the nozzle adapter, wherein the nozzle adapter is operably connected to the transmission line. The atomizing nozzle can have an aperture from which the liquid insect repellent formulation is released under pressure as an atomized mist. The aperture can be from about 0.008 to 0.012 inches in diameter.

In another embodiment of the present invention, the atomized mist may comprise droplets having an average size of less than 50 microns. Preferably, the atomized mist comprises droplets having an average size of from about 2 to 50 microns.

In yet another embodiment of the present invention, there is provided a stable, single-phase atomizable insect repellent liquid composition comprising an active ingredient that has been shown to have insect repellent activity present in an amount of between about 0.2% to about 15% mass/volume, a fixative for reducing the vapour pressure of the active ingredient present in an amount of between about 0.2% to about 10% mass/volume, an emulsifier present in an amount of between about 2% to 15% of, and a solvent liquid.

In yet another embodiment of the present invention, the active ingredient may comprise an essential oil, an isolate of an essential oil, a derivative thereof, or a synthetic equivalent thereof, either alone or in combination.

In yet another embodiment of the present invention, the essential oil may be selected from the group consisting of citronella oil, eucalyptus oil, eucalyptus citriodora oil, geranium oil, lemongrass oil, citrus oils, pine oil, soy oil, peppermint oil, camphor oil, tea tree oil, lavender oil, linseed oil, neem oil, canola oil, jojoba oil, thyme oil, rosemary oil, wintergreen oil, catnip oil, clove oil, garlic oil, cinnamon oil, cassia oil, anise oil, bergamot oil, citrus oil, lavandin oil, mint oil, lemongrass oil, pennyroyal oil either alone or in combination.

In yet another embodiment of the present invention, the active ingredient may also include certain isolates from the above noted oils, derivatives thereof, or the synthetic equivalent thereof, such as p-menthane-3,8-diol from eucalyptus citriodora oil, nepetalactone from catnip oil, geraniol and isomers from geraniol containing oils such as geranium oil, thymol and carvacrol from thyme oil, either alone or in combination.

### DESCRIPTION OF DRAWINGS

Various objects, features and attendant advantages of the present invention will become more fully appreciated and better understood when considered in conjunction with the accompanying drawings, in which like reference characters designate the same or similar parts throughout the several views.

FIG. 1 is a perspective view of an area encompassing a preferred embodiment of an atomizing or misting system of the present invention;

FIG. 2 is a perspective view of a preferred embodiment of a fully assembled misting or atomizing nozzle assembly of the present invention;

FIG. 3 is a perspective view of a preferred embodiment of a fully assembled misting or atomizing nozzle assembly of the present invention in operation;

FIG. 4 is a perspective view of a preferred embodiment of a disassembled misting or atomizing nozzle assembly of the present invention;

FIG. 5 is an expanded perspective view of a preferred embodiment of the fully assembled misting or atomizing nozzle assembly of the present invention attached to a fence as shown in FIG. 1;

FIG. 6 is a perspective view of a preferred embodiment of the controller pump assembly and reservoir of the present invention; and

FIG. 7 is an expanded perspective view of the control panel of the controller pump assembly shown in FIG. 6.

### DETAILED DESCRIPTION OF THE PREFERRED EMBODIMENT

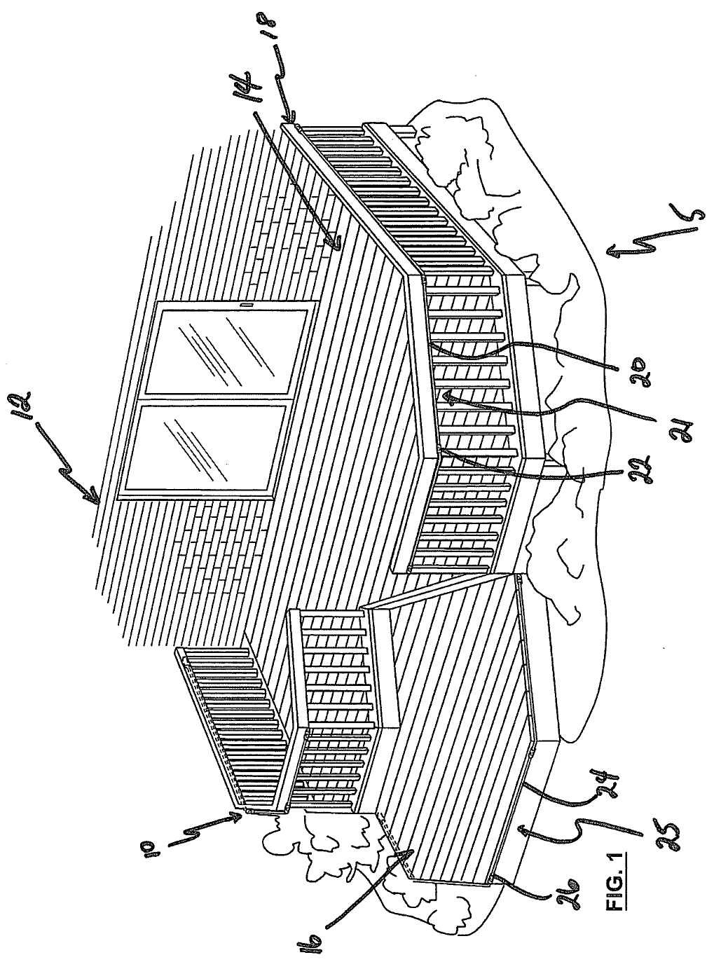

In order that the invention may be more fully understood, it will now by described, by way of example, with reference to the accompanying drawings in which FIGS. 1 through 7 illustrate an aspect of the present invention.

“Natural” or “organic” as used herein refer to naturally occurring, generally non-toxic compounds, include compounds derived from plants, such as essential oils, pyrethrum (pyrethins), rotenone, ryania, neem oil, etc.; or minerals, such as boric acid, cryolite, or diatomaceous earth, as well as isolates thereof, derivative thereof or synthetic equivalents thereof.

Liquid formulations of the present invention may include aqueous solutions or suspensions (such as emulsifiable concentrates, emulsions, or dispersions).

The liquid formulations of the present invention, which can be applied by spraying, misting, or vaporizing, to be used in the apparatus of the present invention, are prepared so as to produce a single phase atomizable liquid or fluid product in which the individual components thereof do not separate or otherwise settle and may contain one of more of the following: from about 0.2% to about 15% mass/volume of an active ingredient having insect repellent properties, from about 0.2% to about 10% mass/volume of an agent for reducing the vapour pressure of the active ingredient (a “fixative”), from about 2% to 15% mass/volume of an emulsifier, from about 0.05% to about 0.2% mass/volume of suitable additives, such as an anti-microbial preservative and, as the carrier, water or another solvent liquid in which the active ingredient may be poorly soluble, have low solubility or be insoluble.

As noted above, prior means of insect pest control have not been sufficiently effective, in that they have not been effective in reducing or eliminating the nuisance and risk factors to humans and animals of insect pests. The present invention is directed to providing an area that has a reduced number of flying insects within the area by creating a zone or perimeter within which there is dispersed a liquid formulation having an active ingredient with insect repellent properties. This zone or perimeter wherein there is dispersed the liquid formulation can be created by way of atomizing the liquid formulation containing the insect repellent active ingredient so as to form a mist, fog or vapour. As a result, the active ingredient dispersed within the mist decreases the number of flying insect within the area. When deployed in the zone around the area, for example, insect pests, particularly flying, biting insect pests, will tend to avoid the zone and the area, which both have an increased concentration of the insect repellent active ingredient dispersed therein so that the presence of such insects within the area is reduced. The methods, apparatus and compositions of the present invention provide for such pest control by which the number of insect pests within the area can be reduced. In doing so, the known problems of previous pest control means may be overcome.

The use of the present invention provides an effective means of insect pest control, without having deleterious effects on the environment. The liquid formulation of the present invention may employ natural or organic insect repellents as an active ingredient. While it may be desirable to kill insect pests as some insect pests may represent a nuisance or risk to animal or human health, the indiscriminant or overuse of insecticides and or pesticides may also kill beneficial insects and thus may be considered environmentally unsound, particularly in residential environments. As an example of this, dragonflies are generally not considered to be insect pests. Dragonflies breed, however, in habitats, such as wetlands, in which other insect pests, such as mosquitoes, also breed. Application of insecticides, pesticides or other toxins that kill mosquitoes can also harm or kill dragonflies. The resulting damage to the dragonfly population results in an increase in the population of their natural prey, such as insect pests such as mosquitoes. This in turn may lead to increases in the spread of diseases borne by the insect pests. As a result, there has been a movement away from the use of insecticides, pesticides and other toxins, synthetic or natural, that indiscriminately kill all insects, towards natural or organic compositions or formulations that repel insects. By combining an insect repellent liquid formulation of the present invention and a system, the active ingredient is atomized and dispersed through a spray, mist/fog, or vapour, the problems of prior art pest control methods and apparatus may be overcome.

Atomizing or misting systems are commonly used wherever it is desirable to produce droplets of a liquid or a liquid solution in the form of a spray, mist, fog or vapor. Atomizing or misting systems have been used in connection with different applications. For example, one application of such systems is to provide a mechanism whereby a subject can be cooled off or refreshed when outdoor temperatures exceed a comfortable or desired level. Other atomizing or misting systems have also been more generally used for climate control (e.g. temperature and humidity), such as in greenhouse applications, as well as in frost prevention, air filtration, fire and smoke prevention, etc.

Typically, in an atomizing or misting system, a fluid or liquid, such as water, is fed under pressure through tubing to one or more atomizer or nozzle assemblies that emit appropriately sized droplets of the fluid or liquid so as to produce a mist, fog or cloud of a desired configuration and composition. In the case of an atomizing or misting system in which the object is to cool a subject, the mist produced can be at or adjacent to where the subject is located. The fluid is typically fed into the atomizing or misting system from a reservoir located remotely from the atomizer or nozzle assemblies by a motorized pump. The motorized pump can be controlled by a controller, which may be programmable, so as to regulate the production of the mist, cloud or fog. For example, U.S. Pat. No. 6,581,655 provides for a water mist cooling system. As shown in FIG. 1, yard 5 is shown, in which the misting or atomizing system 10 of the present invention can be used. As shown in FIG. 1, yard 5 can be adjacent house 12, but it will be understood that the misting or atomizing system 10 of the present invention could be used in any area that requires pest control and does not need to be used in a residential area, such as that illustrated in FIG. 1. However, for the purposes of illustration, a residential area will be shown. Yard 5 has first deck portion 14 and a second deck portion 16. First deck portion 14 has encompassing most of its perimeter a fence or railing portion 18. Attached to railing 18 of first deck portion 14 is a first set of tubing 20 interconnecting a plurality of atomizing or misting nozzles apparatus 22. Attached to the outer edge of second deck portion 16 is a second set of tubing 24 interconnecting a plurality of atomizing or misting nozzles apparatus 26. The misting or atomizing system 10 consists of a plurality of misting or atomizing outlets or assemblies 22 and 26 that are serially connected by the first and second sets of tubing 20 and 24, the tubing 20 and 24 forming transmission lines 21 and 25. Each of transmission lines 21 and 25 has a beginning and an end and may be interconnected. Each of transmission lines 21 and 25 can be controlled by a single controller or can each be separately connected to and controlled by a separate controller. It will be understood that if transmission lines 21 and 25 are interconnected then only a single transmission line will be required or created. It will also be understood that atomizing or misting nozzles apparatus 22 and 26 can be the same or different configuration, except that they function within the parameters outlined herein for the misting or atomizing system 10 of the present invention.

For the present specification, only reference to the first set of tubing 20, atomizing or misting nozzles apparatus 22 and transmission line 21 will be used. Misting or atomizing system 10 can be designed for functioning within a pumping pressure range from 150 to 1000 psi. As noted below, the greater the pressure the smaller the droplet size will be produced from atomizing or misting nozzles apparatus 22. As such, tubing 20 (as well as tubing 24) can be either high or mid pressure tubing depending on the desired operating pressure in which the present invention is to be subjected. An example of mid pressure tubing (pressure range 0 to 450 psi) that can be used in the present invention is Nylon 11 or 12 (¼″ OD by 0.035″ wall thickness) commercially available from Parker Hannifin, IMI Norgren Inc., or Nycoil, Inc. Examples of high-pressure tubing (pressure range 0 to 1200 psi) that can be used in the present invention can be copper or stainless steel tubing (¼″ OD) commercially available from a number of manufacturers. Transmission line 21 connects the misting or atomizing outlets or assemblies 22 to the discharge port of the controller 10 for transmission of a fluid contained within the systems reservoir.

As shown in FIG. 1, the transmission lines 21 and 25 are configured to generally enclose first deck portion 14 and second deck portion 16. In the case of the residential area shown in FIG. 1, the human users or subjects wish to be secured or protected from intrusion by pests, such as flying insects, within first deck portion 14 and second deck portion 16. Transmission line 21 and 25 generally form a perimeter or border encompassing the area of deck portions 14 and 16 to be secured or protected. The surface area of the secured or protected area in the preferred embodiment would be the combined surface area of deck portions 14 and 16. The outer circumference of the area to be secured, namely the outer circumference of deck portions 14 and 16 would generally determine the length of the tubing 20 and 24 required for transmission lines 21 and 25. However, it will be understood that adjustments could be made thereto to accommodate the general layout and circumference of any deck portion or any other area to be protected.

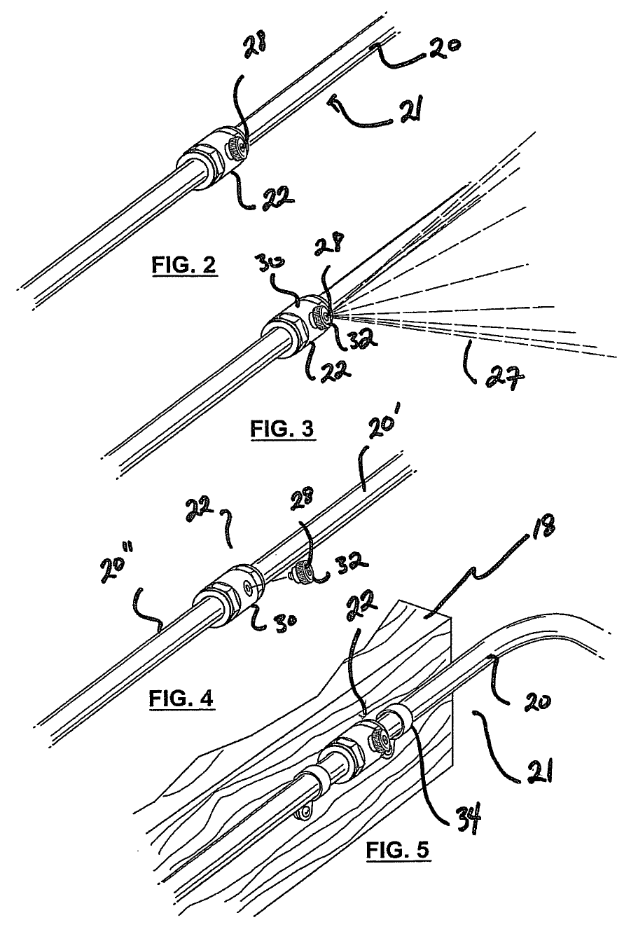

A misting or atomizing outlet or assembly 22 is shown in FIGS. 2 to 5. In operation, the insect repellent liquid formulation or composition of the present invention can be pumped under pressure through transmission line 21 to each of the misting or atomizing outlets or assemblies 22. Each of the misting or atomizing outlets or assemblies 22 is provided with an exit or egresion point 28 so that, in operation as shown in FIG. 3, the pressurized insect repellent liquid formulation within transmission line 21 can exit the assembly 22 in such a manner so as to create a mist or fog 27. When the misting or atomizing system 10 is activated, each of the misting or atomizing nozzle assemblies 22 will dispense droplets of the insect repellent liquid formulation so as to form a mist/fog 27 in a generally inverted cone pattern as shown in FIG. 3. As noted above, the greater the pressure within transmission line 21, the smaller the droplet size.

In operation, the misting or atomizing nozzle assemblies 22 dispense a mist/fog 27 having a spray angle α of between 55 and 75, more preferably between 55 and 70 or between 65 and 75. When the liquid formulation of the present invention is released through the misting or atomizing nozzle assemblies 22, droplets are formed so as to create mist/fog 27. The atomized droplets of the insect repellent liquid formulation tend to be heavier than air and, as a result, settle or sink towards the ground. While doing so, the active ingredient is released into the atmosphere, increasing the concentration of the active ingredient in an area surrounding atomizing nozzle assemblies 22. As the atomized droplets of the liquid formulation settle or sink towards the ground, the active ingredient will continue to be released into the environment. When all of the atomizing nozzle assemblies 22 produce a cloud or mist 27, the overlapping clouds tend to form a zone or perimeter in which the active ingredient is dispersed or atomized, this creating a zone or perimeter of increased concentration of the active ingredients. The atomized active ingredient will gradually disperse throughout the area to be protected. This will act to repel insects away from the area enclosed by the zone or perimeter and will thus reduce the number of insects therein. As a result, the increased concentration of the active ingredient within and generally surrounding areas 14 and 16 will tend to repel insects from areas 14 and 16. The controller repeatedly activates system to dispense mist on timed intervals thus replenishing the concentration of the active ingredient within and generally surrounding areas 14 and 16.

Upon activation of the system 10, a plurality of mist/fog 27 will be produced along the transmission line 21 at each of the misting or atomizing outlets or assemblies 22. As a result, a plurality of such mist will be produced along the perimeter of the deck portions 14 and 16. An area of increased concentration of insect repellent will generally be provided along the perimeter of the deck portions 14 and 16. As noted above, the active ingredient will disperse along the deck portions so that insect pests, particularly flying insects, will tend to avoid deck portions 14 and 16. As the system 10 surrounds the deck portions, the concentration of the active ingredient will generally be higher within the deck portions than outside the deck portions. As a result, the number of insects in or around the deck portions 14 and 16 will be reduced relative to the number outside of the deck portions. People in or around deck portions 14 and/or 16, therefore, will then experience a reduction in the nuisance associate with the insect pests.

The spacing of the misting or atomizing outlets or assemblies 22 along transmission line 21 can be varied to achieve the desired protection from insect pests. For most applications, a spacing of between approximately 10 to 20 feet between each misting or atomizing outlets or assemblies 22 along transmission line 21 can be used to secure and protect the desired area. Further, depending on the level of pest control that is required greater or lesser spacing can be employed. Areas of greater pest infestation may require the placement of misting or atomizing outlets or assemblies 22 closer together (i.e. less than 10 feet between each misting or atomizing outlets or assemblies 22), while areas of lesser pest infestation may produce sufficient barrier effects with placement of misting or atomizing outlets or assemblies farther apart (i.e. greater than 20 feet between each misting or atomizing outlets or assemblies 22). In other words, the number and/or spacing of misting or atomizing outlets or assemblies 22 can be varied, depending on the size of area to be protected and secured, the environmental conditions (e.g. average wind speed, temperature during use, etc. Environmental factors such as wind and rain may determine when the controller will activate the system. For example, if it is raining, the system may not be activated. If it is windy the frequency of activation may increase. Environmental factors that affect flying insect populations may result in a direct correlation to the usage, frequency of application of the system and the desired concentration of the solution.

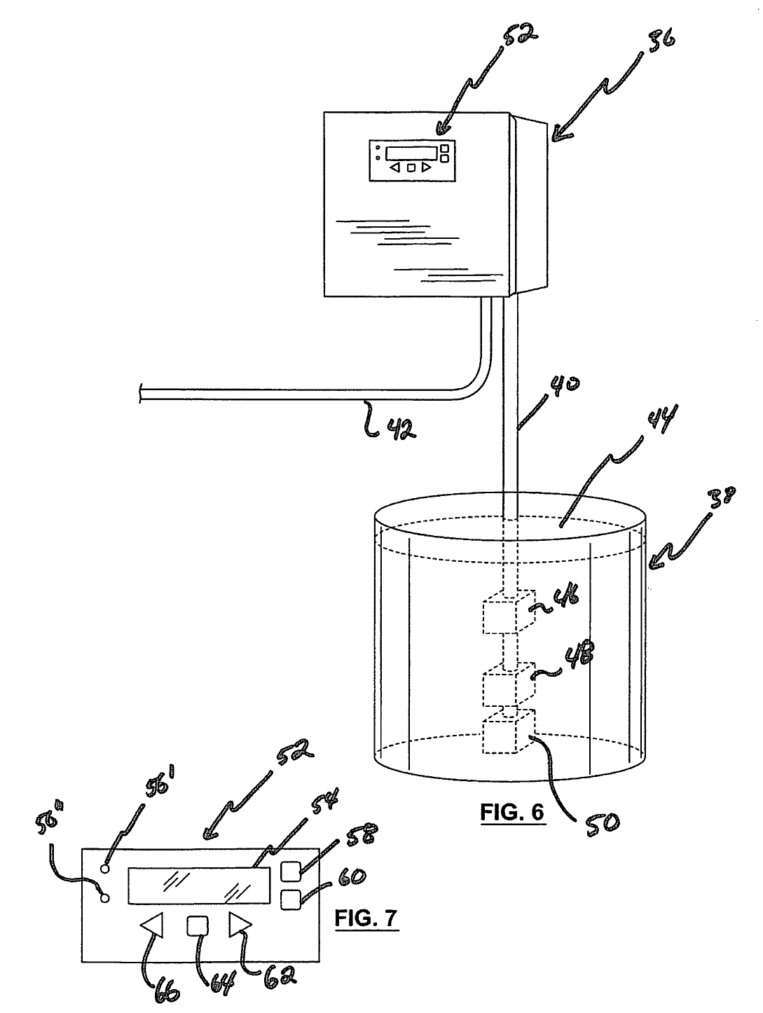

Mist or atomizer nozzle assemblies 22 of the type that may be used in the present invention are well known. Examples of such assemblies are those sold by Arizona Mist, Fogco Inc. and others. In a preferred embodiment shown in FIGS. 2 to 4, a mist or atomizer nozzle assembly 22 is provided and comprises a nozzle adapter 30, as shown in FIG. 4, designed to functionally connect the two individual sets of tubing 20, tubing 20′ and 20″, of the transmission line 21 and receive the atomizing nozzle 32. As shown in FIG. 3, an atomizing or misting nozzle 32 is in operative connection with the nozzle adapter 30 so that fluid under pressure within the tubing 20 of the transmission line 21 can exit from egression or exit aperture 28 upon activation of the system 10. As shown in FIG. 4, the atomizing or misting nozzle 32 can be removable from nozzle adapter 30, for cleaning, replacement, etc., without disassembling the entire system 10 or disconnecting the sets of tubing 22 from the nozzle adapter 30. As shown in FIG. 5, the mist or atomizer nozzle assemblies 22 is attached to railing 18 by way of tubing clamps 34. The mist or atomizer nozzle assembly 22 preferably is designed to produce a mist/fog 27 having fluid droplets of from 2 to 50 microns, more preferable between 5 and 20 microns, to achieve the most effective dispersion. The mist or atomizer nozzle assemblies 22 must be suitable for producing a mist/fog having an inverted cone or full cone pattern wherein the widest portion of the cone having a diameter of between approximately 10 feet and approximately 20 feet. The preferred size of the egression or exit aperture 28 is from about 0.008 to 0.012 inches in diameter.

FIG. 6 shows a controller pump assembly 36 connected to reservoir 38 by way of tubing 40. As shown in FIG. 6, there is also provided tubing 42 which connects the controller-pump assembly to transmission lines 21. The controller-pump assembly 36 provides for the activation of the system 10 based on either preset commands or user specified criteria by way of a controller (not shown). Controller pump assembly 36 contains a pump (not shown) to provide the pressure by which the liquid formulation 44 of the present invention is transmitted from the reservoir 38, through the tubing 40 to the controller-pump assembly 36, through tubing 42 to the transmission line 21 and to the mist or atomizer nozzle assemblies 22. Typical pumps include dynamic or centrifugal pumps (e.g. radial flow, mixed flow, axial flow, etc.) as well as positive displacement pumps (e.g. single rotor vane, piston, flexible member, duplex and triplex plunger, single crew, etc.) or multiple rotors (gear, lobe, circumferential piston, multiple screw, etc.). The pump provides for the liquid formulation 44 of the present invention to be pumped at pre-selected or predetermined pressures through the transmission line 21 to the misting or atomizing outlets or assemblies 22. Pumping rates range from 2.74 to 4.93 litres/hour within an operating pressure range of 150 to 1200 psi respectively.

As shown in FIG. 6, the supply inlet of the controller pump assembly 36 is adjustably connected to an outlet of a supply or reservoir 38 containing the liquid formulation 44 of the present invention by way of the supply inlet tubing 40, while a transmission outlet is adjustably connected to the transmission line 21 of the misting system by way of the transmission outlet tubing 42. The supply inlet tubing 40 is operatively connected to the reservoir 38 so as to allow the liquid formulation 44 of the present invention to be pumped under pressure from the reservoir 38 into the transmission lines 21 via the supply inlet tubing 40 and the transmission outlet tubing 42. In a preferred embodiment, the supply inlet tubing 40 may be weighted down in the reservoir by weights 46 and 48. It will be understood that while two weights are shown in FIG. 6, either one weight or any combination of weights may be used so as to achieve the operable contact of inlet supply tube 40 with the liquid formulation of the present invention 44. A valve, such as a “foot-valve strainer” 50, is functionally attached to the end of the supply inlet tubing 40 that is located within the reservoir 38 and is operatively connected to the liquid formulation of the present invention. The opposite end of the supply inlet tubing 40 is connected to the controller pump assembly 36 so that when the pump is activated by the controller, the liquid formulation 44 is transferred or pumped from the reservoir 38 to the transmission line 21 and ultimately through the mister or atomizer assemblies 22.

An auto drain valve assembly can be connected to the transmission outlet tubing 42 to prevent dripping of the liquid formulation from misting nozzles 32 as caused by residual pressure in tubing following pump shut down. Auto drain valve assembly is designed to open at pressures below 70 psi to release pressure in outlet tubing 42 on pump shut down and drain residual solution from tubing to reservoir 38 (not shown).

Upon activation of the pump by the controller, the liquid formulation of the present invention is pumped under pressure from the supply or reservoir via the supply inlet into the transmission line via the transmission outlet into the transmission line of tubing serially connecting the misting or atomizing outlets or assemblies. The fluid solution is then released into the surrounding environment as a mist/fog adjacent to the perimeter or border encompassing the area to be secured or protected, thus creating a barrier encompassing the area to be secured or protected. Due to the composition of the misted liquid formulation, insect pests are prevented from entering the area to be protected or secured.

The pump is controlled by a controller, which may be programmable, whereby the controller, based on either pre-determined parameters or parameters programmed by a user, controls the flow of the fluid solution of the present invention through the transmission line and ultimately the misting or atomizing outlets or assemblies. It will be understood that the controller and pump can be the same apparatus, as outlined above as the controller-pump assembly 36. While preferably the controller-pump assembly is contained within a single item or apparatus, it will also be understood that the controller and the pump need not be contained in the same apparatus.

In one embodiment, the user can control the frequency of the activation of the misting or atomizing system of the present invention. In addition, wind, rain, low level tank sensors, such as those manufactured by Omron Corporation, Intermatic, Inc., etc. can be provided. In a preferred embodiment, input 52 typically has a user interface, as shown in FIGS. 6 and 7, so as to allow a user to program the conditions under which the liquid formulation will be released through the misting or atomizing outlets or assemblies. In a preferred embodiment shown in FIG. 7, the user interface may consist of a 2 by 16 character liquid crystal display (“LCD”) 56, 2 light emitting diodes (“LED”), 56′ and 56″, and user input buttons 58 to 66. It will be understood that any configuration which allows a user to easily program the controller-pump assembly could be used.

In the preferred embodiment provided in FIG. 7, LCD display 56 is used to display the status of the atomizing system and the necessary information required during use. As seen in FIG. 7, each of LED 56′ and/or 56″ can be used to indicate “POWER ON/OFF”, 56′ which indicates whether the atomizing system is on or off and “SPRAY”, 56″ which indicates the status of the pump (i.e. whether the pump has been activated by the controller). As provided in FIG. 7, the buttons 58 to 66 can be used for various functions such as, “POWER” 58 (used to turn the controller, which in turn controls the atomizing system, power on and off), “MANUAL” 60 (used to manually operate the pump and as a master exit button from the setup menus), “MODE” 64 (used to enter and scroll through the setup menus), “ [symbol] ” 66 (used to scroll through the setup menus and adjust down the selected setup menu item), and “ [symbol] ” 62 (used to scroll through the setup menus and adjust up the selected setup menu item).

The user may choose to either program the controller to operate under a pre-programmed set of conditions or may chose to operate the controller manually. In a preferred embodiment, the user may choose to program the controller. Several parameters may be controlled such as the date on which the controller/pump assembly, also known as “events”, can be activated, the time on which the controller/pump assembly can be activated, the pump & motor duty cycle, namely the rate of cycling between off and on which in other words is when the controller/pump assembly causes a mist, spray, fog etc. to be released from the nozzle assembly, or any combination thereof. Each event consists of an “ON TIME”, preferably 20 sec. and an “OFF TIME”, preferably 10 min. A person skilled in the art will understand that different programming is possible, such as for example, each day of the week can have a series of ON Times and OFF Times which are different from other days of the week. Alternatively, Monday through Friday may have the same schedule of events while Saturday and Sunday could have the same schedule of events but different from the schedule of events from each of Monday through Friday. It will be understood, therefore, that almost an infinite schedules of events could be possible.

In a preferred embodiment, the pump can be manually operated to turn on for a pre-set 30-second interval by pressing and releasing the ‘MANUAL’ button 60. The manual button 60 is operational only when the system is in the off state. When the Manual button 60 is pressed the LCD 54 displays ‘Manual: ss’ indicating that the controller-pump assembly is in manual mode and a countdown timer displaying the time remaining in manual mode. When the countdown reaches zero the manual operation ends and the controller/pump assembly cycles to an OFF time. In a preferred embodiment, a backlit LED display may be illuminated during manual operation to indicate that the controller/pump assembly has cycled to an ON Time.

Misting or atomizing outlets or assemblies 22 can be mounted to the tubing 21 by cutting the tubing, inserting the two cut ends of the tubing into each side of the nozzle adapter 30 and hand tightening the nozzle 32 into the nozzle adapter 30. In a preferred embodiment, misting or atomizing outlets or assemblies 22 should be installed at 45 degrees upward angle from horizontal, as shown in FIGS. 2 to 5 to achieve optimal mist/fog formation and formulation dispersion, as shown in FIG. 3. However, it will be understood that any configuration of misting or atomizing outlets or assemblies that produces the desired mist/fog formation and formulation dispersion as noted above and as required by the present invention would be encompassed.

The spacing of the misting or atomizing outlets or assemblies can be varied in different sections to achieve greater misting benefits in critical areas. Typically one controller/pump assembly may be capable of powering up to 50 misting or atomizing outlets or assemblies over a linear distance of approximately 1,000 feet. For most applications, an average misting or atomizing outlets or assemblies spacing of between approximately 10 to 20 feet can be used for effective coverage over linear areas (i.e. fence lines). However, depending on the level of pest control that is required less or more can be used. Number and spacing of nozzles varies according to area to be treated. Spacing is typically 10 to 20 feet The timing between bursts and the duration of the burst can be determined by the user to select the optional level of bug repellance. Typically, the controller/pump assembly controls the timing between bursts to within 5 to 20 minutes, preferably 5 to 15 minutes and still preferably 10 minutes. The controller pump assembly also allows for a duration of misting of between 5 to 30 seconds, preferably between 10 to 25 seconds, more preferably 20 seconds.

Liquid Formulation of the Present Invention

The fluid formulation of the present invention is an insect repellent formulation that is formulated to produce a stable, single-phase atomizable liquid for use in mid-pressure pumping atomization systems, such as the one disclosed herein, when diluted with water. The fluid solution of the present invention can be supplied as a concentrate, which can be then diluted on site.

The insect repellent liquid formulation may comprise an active ingredient that has been shown to have insect repellent activity present in an amount of between about 0.2% to about 15% mass/volume. The insect repellent liquid formulation may also comprise a fixative for reducing the vapour pressure of the active ingredient present in an amount of between about 0.2% to about 10% mass/volume, an emulsifier present in an amount of between about 2% to 15% of, and a solvent liquid.

The active ingredient may comprise an essential oil, an isolate of an essential oil, a derivative thereof, or a synthetic equivalent thereof, either alone or in combination.

For example, the essential oils can include, either alone or in combination, citronella oil, eucalyptus oil, eucalyptus citriodora oil, geranium oil, lemongrass oil, citrus oils, pine oil, soy oil, peppermint oil, camphor oil, tea tree oil, lavender oil, linseed oil, neem oil, canola oil, jojoba oil, thyme oil, rosemary oil, wintergreen oil, catnip oil, clove oil, garlic oil, cinnamon oil, cassia oil, anise oil, bergamot oil, citrus oil, lavandin oil, mint oil, lemongrass oil, and pennyroyal oil.

The active ingredient may also include certain isolates from the above noted oils, derivatives thereof, or the synthetic equivalent thereof, such as p-menthane-3,8-diol from eucalyptus citriodora oil, nepetalactone from catnip oil, geraniol and isomers from geraniol containing oils such as geranium oil, thymol and carvacrol from thyme oil, either alone or in combination.

The liquid formulation may also include at least one compound that extends the activity of the active chemical ingredient by reducing the vapour pressure (i.e. evaporation rate or volatility) of the other, more volatile compounds such as the active chemical ingredient. The fixative, for example, can include glycerol, cedarwood oil, sandalwood oil, vertiver oil and patchouli oil and could include natural musk extracts such as civet extract, castoreum, ambergris, natural or synthetic glycerine, or any liquid of low vapour pressure

Non-active ingredients such as emulsifiers may also be included such as, for example, polysorbate 20 and other similar grade emulsifiers of identical or generally similar hydrophobic-lypophobic balance and may be include mono-glyceride derivatives, poly-oxyethylene nonyl phenolethers, and sugars esters and sodium lauryl sulphate, emulsifiers in the class polyoxyethylene condensation products with derivatives of sorbitol, lecithin of various origins such as soy and egg yolk

### EXAMPLE 1

TABLE 1

| Item | | % | |
|---|---|---|---|
| # | Ingredient (CAS No.) | mass/volume* | Purpose |
| 1 | Eucalyptus citriodora oil | 2.00 | Active ingredient |
| | (8000-48-4) | | |
| 2 | Cedarwood oil (68990-83-0) | 0.25 | Fixative |
| 3 | Polysorbate 20 (9005-64-5) | 7.00 | Emulsifier |
| 4 | Sodium lauryl sulphate | 0.30 | Emulsifier |
| | (151-21-3) | | |
| 5 | Potassium sorbate | 0.10 | Preservative |
| | (590-00-1) | | |
| 6 | Water | 90.35 | Solvent |

*For all tables, wherein the ingredient concentrations are expressed
as % mass/volume, it is calculated from the following equation:
$\% m / V = \frac{grams of item}{volume of final solution in milliliters} \times 100 \%$

The above noted formulation was prepared as follows. Items 1 and 2 were mixed with Item 3 with constant stirring. 80 parts of water was added with constant stirring. Item 4 was pre-dissolve in water and added to the above noted mixture of items 1, 2 and 3 with constant stirring. Item 5 was pre-dissolve in water and added to the mixture of items 1 to 4 with constant stirring. Sufficient water was added with constant stirring to produce a final volume equal numerically to 100 parts. The final product is an off-white emulsion with a Specific Gravity of about 1.01.

### EXAMPLE 2

TABLE 2

| Item | | | |
|---|---|---|---|
| # | Ingredient (CAS No.) | % mass/volume* | Pupose |
| 1 | Citronella oil | 2.50 | Active ingredient |
| 2 | Gum Arabic | 10.00 | Emulsifier |
| 3 | Water | 87.50 | Solvent |

*For all tables, wherein the ingredient concentrations are
expressed as % mass/volume, it is calculated from the
following equation:
$\% m / V = \frac{grams of item}{volume of final solution in milliliters} \times 100 \%$

The above noted formulation was prepared as follows. Item 2 was mixed with one fourth of item 3 until solubilized. Item 2 was added with constant stirring. The remaining water was added with constant stirring. The complete formulation was homogenized to produce a stable emulsion. The final product is an off-white emulsion with a Specific Gravity of about 1.01.

### EXAMPLE 3

TABLE 3

| Item | | | |
|---|---|---|---|
| # | Ingredient (CAS No.) | % mass/volume* | Pupose |
| 1 | Citronella oil | 2.50 | Active ingredient |
| 2 | Xanthan Gum | 10.50 | Emulsifier |
| 3 | Water | 87.50 | Solvent |

*For all tables, wherein the ingredient concentrations are expressed
as % mass/volume, it is calculated from the following equation.
$\% m / V = \frac{grams of item}{volume of final solution in milliliters} \times 100 \%$

The above noted formulation was prepared as follows. Item 1 was mixed with Item 3 and homogenized to produce a stabile emulsion of the oil in the water. Item 2 was added slowly with constant stirring. The final product is an off-white emulsion with a Specific Gravity of about 1.01.

Field Testing

The field efficacy testing for the embodiments of the present invention was configured using two or more test 20 feet by 20 feet areas defined as outdoor locations, known or expected to yield high numbers of mosquitoes. One area was defined as a control, while a second area was defined as a treated area. The two areas were not to be separated by more than 50 feet. The efficacy is determined by comparing the number of mosquitoes captured in each area over a 12 hour period over three separate days. The treated area(s) were downwind of control area so as to prevent contamination of control area with atomized repellent solution from the treated areas.

Within each area, a standard mosquito surveillance tool (i.e. CDC light trap with CO₂) was positioned to record the number of mosquitoes captured in the CDC light trap with CO₂. In the treated area(s), an embodiment of the present invention is installed and programmed from a defined “On”/“Off”, intermittent spray cycle.

TABLE 4
Field Efficacy Study

| Test Sample | Average No. of Insects Captured* |
|---|---|
| Formulation | 19.3** |
| Control | 62*** |
| % Mean Reduction | 68.87**** |

*Average Number of flying insects (e.g. mosquitoes) captured in a CDC light trap with CO₂ over 12 hour period on three separate occasions on July 12, 16 and 20, 2004
**Average of number of flying insects caught in area surrounded by embodiment of the present invention using the formulation of Example 2 on July 12 (35), 16 (9) and 20 (14)
***Average of number of flying insects caught in control area on July 12 (107), 16 (30) and 20 (49)
****% Reduction calculated by ((No. of Insects Caught in Control) − (No. Of Insects caught in Formulation))/(No. of Insects Caught in Control)

As shown in Table 4, the formulation of Example 2 reduced the number of flying insects in the test area by 68.87%.

While the invention has been described in terms of various preferred embodiments, the skilled artisan will appreciate that various modifications, substitutions, omissions and changes can be made without departing from the spirit thereof. Accordingly, it is intended that the scope of the present invention be limited solely by the scope of the following claims, including equivalents thereof.

We claim:

1. A system for decreasing the number of insects within an area to be protected, the system comprising a pump for pumping a liquid insect repellent formulation from a reservoir into a transmission line and pressurizing the liquid insect repellent formulation within the transmission line, the transmission line having at least one atomizing assembly operably connected to the transmission line so that when the a liquid insect repellent formulation is pressurized in the transmission line the liquid insect repellent formulation is released from the atomizing assembly as an atomized mist.

2. The system of claim 1 wherein the atomizing assembly is comprised of a nozzle adapter and an atomizing nozzle operably connected to the nozzle adapter, wherein the nozzle adapter is operably connected to the transmission line.

3. The system of claim 2 wherein the atomizing nozzle has an aperture from which the liquid insect repellent formulation is released under pressure as an atomized mist.

4. The system of claim 3 wherein the atomized mist comprises droplets having an average size of less than 50 microns.

5. The system of claim 3 wherein the atomized mist comprises droplets having an average size of from about 2 to 50 microns.

6. The system of claim 3 wherein the aperture is from about 0.008 to 0.012 inches in diameter.

7. The system of claim 6 wherein there are at least two atomizing assemblies.

8. The system of claim 7 wherein the liquid insect repellent formulation is a stable, single-phase atomizable liquid.

9. The system of claim 8 wherein the liquid insect repellent formulation comprises an active ingredient having insect repellent activity.

10. The system of claim 9 wherein the active ingredient is an essential oil, an isolate of an essential oil, a derivative thereof, or a synthetic equivalent thereof, either alone or in combination.

11. The system of claim 10 wherein the essential oil is selected from the group consisting of citronella oil, eucalyptus oil, eucalyptus citriodora oil, geranium oil, lemongrass oil, citrus oils, pine oil, soy oil, peppermint oil, camphor oil, tea tree oil, lavender oil, linseed oil, neem oil, canola oil, jojoba oil, thyme oil, rosemary oil, wintergreen oil, catnip oil, clove oil, garlic oil, cinnamon oil, cassia oil, anise oil, bergamot oil, citrus oil, lavandin oil, mint oil, lemongrass oil, and pennyroyal oil.

12. The system of claim 10 wherein the isolate is selected from the group consisting of p-menthane-3,8-diol from eucalyptus citriodora oil, nepetalactone from catnip oil, geraniol and isomers from geraniol containing oils such as geranium oil, thymol and carvacrol from thyme oil, either alone or in combination thereof.

13. The system of claim 10 wherein the pump is cycled on and off by a controller.

14. The system of claim 13 wherein the controller is programmable.

15. The system of claim 14 wherein the pests are insects.

16. The system of claim 15 wherein the insects are flying insects.

17. A stable, single-phase atomizable insect repellent liquid composition comprising
a. an active ingredient having insect repellent properties present in an amount of between about 0.2% to about 15% mass/volume;
b. a fixative for reducing the vapour pressure of the active ingredient present in an amount of between about 0.2% to about 10% mass/volume;
c. an emulsifier present in an amount of between about 2% to 15% of; and
d. a solvent liquid.

18. The system of claim 17 wherein the active ingredient is an essential oil, an isolate of an essential oil, a derivative thereof, or a synthetic equivalent thereof, either alone or in combination.

19. The system of claim 18 wherein the essential oil is selected from the group consisting of citronella oil, eucalyptus oil, eucalyptus citriodora oil, geranium oil, lemongrass oil, citrus oils, pine oil, soy oil, peppermint oil, camphor oil, tea tree oil, lavender oil, linseed oil, neem oil, canola oil, jojoba oil, thyme oil, rosemary oil, wintergreen oil, catnip oil, clove oil, garlic oil, cinnamon oil, cassia oil, anise oil, bergamot oil, citrus oil, lavandin oil, mint oil, lemongrass oil, and pennyroyal oil.

20. The system of claim 19 wherein the isolate is selected from the group consisting of p-menthane-3,8-diol from eucalyptus citriodora oil, nepetalactone from catnip oil, geraniol and isomers from geraniol containing oils such as geranium oil, thymol and carvacrol from thyme oil, either alone or in combination thereof.
